(19) United States
(12) Patent Application Publication
(10) Pub. No.: US 2018/0088920 A1
(43) Pub. Date: Mar. 29, 2018

(54) MOBILE TRANSPARENT COMPUTING IMPLEMENT METHOD BASED ON MACHINE CODE MIGRATION

(71) Applicant: TSINGHUA UNIVERSITY, Beijing (CN)

(72) Inventors: Chao Wu, Beijing (CN); Yaoxue Zhang, Beijing (CN)

(21) Appl. No.: 15/719,050

(22) Filed: Sep. 28, 2017

(30) Foreign Application Priority Data
Sep. 28, 2016 (CN) 2016108613510

(51) Int. Cl. G06F 9/45; H04L 29/06; H04L 29/08

(52) U.S. Cl. CPC G06F 8/4432; G06F 8/4441; H04L 67/34; H04L 63/1416

(57) ABSTRACT

A mobile computing implementation method is based on machine code migration, and permits mobile devices to directly use machine codes generated by other mobile devices, so that generated machine codes can be shared between devices and implemented directly, without complex intermediate steps. The method can include techniques for machine code generation and extraction and OS binder operation, and mechanisms for failure recovery and garbage collection. A security mechanism can protect the system. Low-efficiency processes, such as compilation, are performed beforehand by a small number of mobile devices and then the generated machine codes and the resources are cached in a CDN server. On this basis, any mobile user can send a functionality request to a server, and then incrementally download corresponding resources for direct performing. Execution efficiency and energy costs can be improved on many mobile applications for many mobile devices, including mobile phones, smart watches, tablets, and smart glasses.

### TECHNICAL FIELD

The invention relates to a technique of optimal mobile devices user experience which can be implemented by machine code migration, which belongs to a field of mobile computing.

### BACKGROUND

The number of mobile applications has undergone tremendous growth since the inception of application markets. Up to June 2016, more than 2 million applications are available on Google Play. Today's users can access to many and multi-purpose applications. While providing user rich services and attractive features, onerous workload of SoC and frequent data exchanging also make users suffer from some bad user experience, such as severe battery exhaustion, increasing size of user's residual files, and long application initialization latency. Based on the analysis of application use behavior of 90128 volunteers, each application user consumes averagely more than 2,000 J electrical energy and over 100 MB data flow, and then generates more than 3 MB residual user-related files during use process for each day.

In order to optimize energy consumption and latency, existing method includes code offloading which is used in the circumstance where there has been a disparity between the computational powers of available computing devices. The idea has known in popularity with the concept of cloud computing, and many low-powered, well-connected computing devices could benefit from the computation of nearby server-class machines, so as to decrease cost of computing and energy. However, the method requires specialized facilities for undertaking corresponding services in addition to basic network infrastructure, which usually brings expensive cost. Also, the method cannot solve a problem of residual files. As to this drawback, mobile cloud application is proposed, whereby application developers can develop cross-platform applications easily. In particular, mobile cloud app can solve the residual file issue, since all data for running applications are synchronized from server and no file is cached locally. By implementing over CDN, users can further decrease latency when using applications. However, it cannot reduce device's energy consumption. Both prior solutions benefit users from different aspects. Unfortunately, neither of them can provide users all the demands of the mobile app (low latency, no residual files, minimum energy cost, and no specialized facilities).

This invention tends to provide a high quality experience (low latency, no residual file, minimum energy cost, and no specialized facilities) to mobile device users. This invention provides a newly transparent computing mode, which transform functional demands of user into computing and avoid tedious mediate steps. Specifically, the invention designs a method which makes mobile devices directly use machine codes generated by other mobile devices, so that generated machine codes can be shared between devices and can be implemented directly, and complex mediate steps can be avoided. The invention discloses a technique of machine code generation and extraction and OS binder operation, and a mechanism of failure recovery and garbage collection. Moreover, perfect security mechanism is provided to protect the system from viciously attacking. In this invention, low efficient processes, e.g., compilation, are performed beforehand by a small number of mobile devices and then the generated machine codes and the resources are cached in the CDN server. On this basis, any mobile user can send a functionality request to a server, then incrementally download corresponding resource for direct performing. Compared to conventional mobile application approaches, this invention provides an average speed-up of 9.90×. In regular use, it is able to reach as much as 120× speed-up on average. The present invention provides a novel computing way which can significantly change the way user use mobile applications, in order to provide better user experience to users. This invention can be applied in many mobile applications for many mobile devices (e.g., mobile phone, smart watch, tablet, smart glasses) to improve the execution efficiency and save energy cost.

### SUMMARY

The purpose of the present invention is to provide a mobile transparent computing method based on machine code migration, which will make user directly perform machine codes of desired function by sharing machine codes of application program between mobile devices, so as to meet the high quality experience demand to mobile application (low latency, no residual file, minimum energy cost, and no specialized facilities).

The mobile transparent computing method based on machine code migration of the present invention has following advantages: mobile device user can omit the mediated process of code compilation and interpretation and so on and significantly improve the execution speed and decrease latency by directly running machine codes of desired functions. Compared to conventional mobile application approaches, this invention provides an average speed-up of 9.90×. In regular use, it is able to reach as much as 120× speed-up on average. Since desired resources can be attained by synchronizing from a server and no file is cached locally, user's residual files can be effectively eliminated. At the same time, in the invention, hard tasks are completed beforehand by a small number of mobile devices, then electricity consumption of most of devices will be saved and continuous working time of devices will be prolonged effectively. Moreover, the invention does not need any particular device. The novel computing way of the present invention will can significantly change the way user use mobile applications, in order to provide better user experience to users.

### BRIEF DESCRIPTION OF THE DRAWINGS

FIG. 1: Machine codes migration between mobile devices to increase running speed and to decrease energy cost is shown;

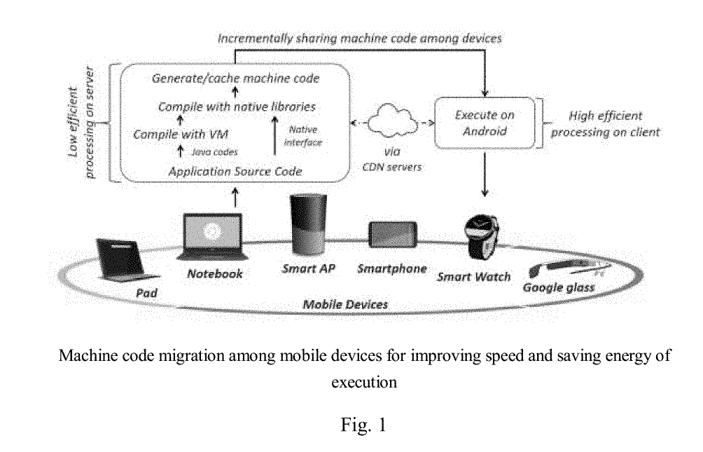

FIG. 2: Workflow of this invention is shown; and

FIG. 3 Workflow of machine code sharing is shown.

### DETAILED DESCRIPTION OF THE PREFERRED EMBODIMENTS

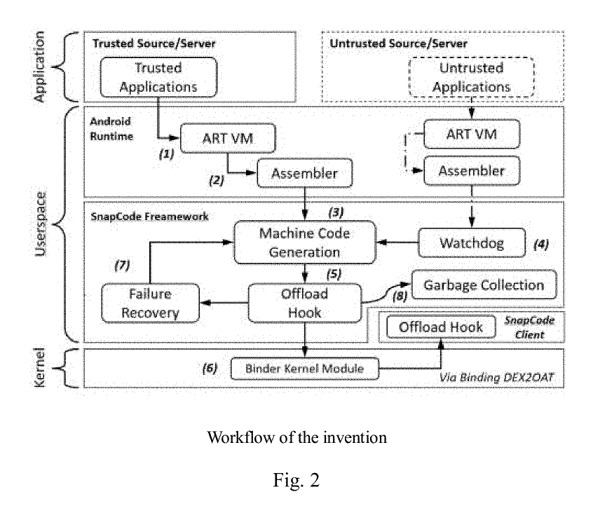

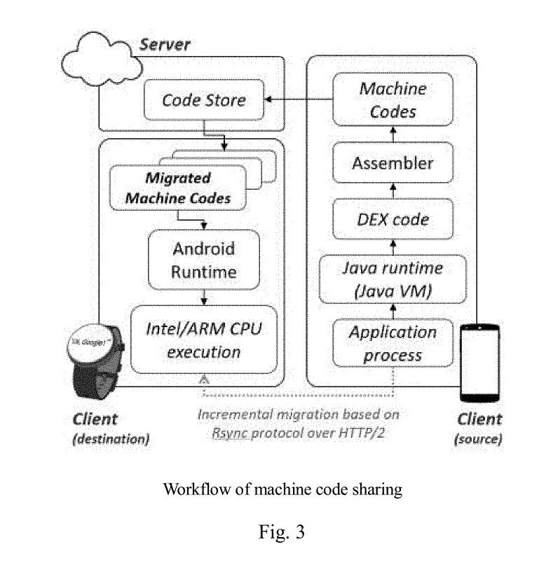

The present invention provides a mobile transparent implement computing method based on machine code migration, and to devices provided with a small amount of machine codes, workflow of the method has following 8 steps as shown in FIG. 2-3:

(1) a mobile device downloads application source program and desired resource (e.g., icons, pictures, audio) from application program service source/server; after downloading a source program pack, an assemble of the application is generated by invoking interpreter interface function when running native Android;

(2) the assembler output from step (1) is input into an assembly module;

(3) the assembler generates OAT file through a linking process;

(4) if the application is from untrusted resource, a system employs a security module to detect malicious code to machine codes output from step (3); if the application is from trusted resource, step (4) will be skipped and step (5) will be executed;

(5) the mobile device uploads the generated machine codes to CDN content servers for further improved malicious code checks;

(6) when the mobile device need to execute an application function, the machine code and the resource of the application are only incrementally synchronized to local from a content server (e.g., use the HTTP/2 and Rsync protocols), and can be directly executed in CPU;

(7) if the uploads and downloads of the machines codes failed, the mobile device or the sever can recover the uploads and downloads process;

(8) after the download machine codes and corresponding resource are used, user is able to cache the downloaded machine codes locally for regular uses, or clean them up. Garbage collection function of the present invention cleans locally residual file automatically.

For most of the device which executes application using the present invention, refer to FIG. 2 and FIG. 3, the workflow thereof includes the following 3 steps:

(1) when the mobile device need to execute an application function, the machine code and the resource of the application are only incrementally synchronized to local from the content server (e.g., use the HTTP/2 and Rsync protocols), and can be directly executed in CPU;

(2) if the uploads and downloads of the machines failed, the mobile device or the sever can recover the uploads and downloads process;

(3) after the download machine codes and corresponding resource are used, user is able to cache the downloaded machine codes locally for regular uses, or clean them up. Garbage collection function of the present invention cleans locally residual file automatically.

1. A mobile transparent implement computing method based on machine code migration, characterized in that, to devices provided with a small amount of machine codes, workflow of the method has following 8 steps:
(1) a mobile device downloads application source program and desired resource from application program service source/server; after downloading a source program pack, an assemble of the application is generated by invoking interpreter interface function when running native Android;
(2) the assembler output from step (1) is input into an assembly module;
(3) the assembler generates OAT file through a linking process;
(4) if the application is from untrusted resource, a system employs a security module to detect malicious code to machine codes output from step (3); if the application is from trusted resource, step (4) will be skipped and step (5) will be executed;
(5) the mobile device uploads the generated machine codes to CDN content servers for further improved malicious code checks;
(6) when the mobile device need to execute an application function, the machine code and the resource of the application are only incrementally synchronized to local from a content server (e.g., use the HTTP/2 and Rsync protocols), and can be directly executed in CPU;
(7) if the uploads and downloads of the machines codes failed, the mobile device or the sever can recover the uploads and downloads process;
(8) after the download machine codes and corresponding resource are used, user is able to cache the downloaded machine codes locally for regular uses, or clean them up; garbage collection function cleans locally residual file automatically.

2. The mobile transparent implement computing method based on machine code migration according to claim 1, characterized in that, the machine code generation of step (3) comprises the steps of:
at install time, ART compiles applications using the on-device dex2oat tool that accepts DEX files as input and generates a compiled application executable (OAT files) for the target device; by listening such process, executable codes, i.e., machine codes can be extracted from OAT files.

3. The mobile transparent implement computing method based on machine code migration according to claim 1, characterized in that, the running synchronized machine code of step (6) comprises the steps of:
when the device synchronize the machine codes from CDN, an OS binder is invoked to patch objects, i.e., machine codes, static resources and environmental parameters, to DEX2OAT interfaces of the system; to guarantee a secure OS binder, uses ADBI toolkit is used to hook the functions of CallNonVirtual<Type>Method family.

4. The mobile transparent implement computing method based on machine code migration according to claim 1, characterized in that, the failure recovery method in step (7) comprises the steps of:
any one operation that can be executed must meet one of both conditions: it is suspended for all remote acknowledgements to arrive before removing any downloaded machine codes; it is finished before a regular synchronization completes; to recover from a failure, the client needs only resume all threads locally and reset the machine code synchronization.

5. The mobile transparent implement computing method based on machine code migration according to claim 1, characterized in that, the garbage collection method in step (8) comprises the steps of:
for any one of applications, all objects that are accessed locally can be addressed through file path; when all processes of such application is terminated by ART, the application's executable codes and static resources would be moved to a trash temporally; objects in the trash can be recovered if faulty operation appears; the objects in trash would be cleaned up automatically if no further access over a certain time.

6. The mobile transparent implement computing method based on machine code migration according to claim 1, characterized in that, the security module of step (4) is:
(1) a valid CDN server is authenticated by a certificate, which is authorized by a trusted CA and can be examined by any client;
(2) to validate a client, when a user installs the client from an authorized server, he/she will be provided a unique pair of keys (a public key and a private key) associated to his/her account and device identity;
(3) before uploading a piece of machine codes from the client, a digest of the codes will be generated and signed with the client's private key, then the codes as well as the signature will be uploaded to an authorized server; the server maintains detailed tables of valid users and applications, and examines whether the uploaded signature is from valid users firstly and then examines whether the machine code is correct using the digest; and in this way, untrusted client uploading incorrect machine code can also be detected and tracked by its private key;
(4) it is suggested to use HTTPS protocol to ensure the integrity and confidentiality of transmission message;
(5) to further improve the whole system security and user experience, it is suggested to employ the untrusted third-party application analysis methods to identify misbehaving applications.
